(19) United States
(12) Patent Application Publication
(10) Pub. No.: US 2005/0186526 A1
(43) Pub. Date: Aug. 25, 2005

(54) Methods and systems for enabling and stabilizing tooth movement

(75) Inventors: Dennis R. Stewart, Los Gatos, CA (US); Peter M. Breining, San Mateo, CA (US); Jonathan L. Nicozisis, Pennington, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BAS Medical, Inc., San Mateo, CA (US)

(21) Appl. No.: 11/015,093

(22) Filed: Dec. 16, 2004

Related U.S. Application Data
(63) Continuation-in-part of application No. 10/695,299, filed on Oct. 27, 2003.
(60) Provisional application No. 60/423,026, filed on Nov. 1, 2002.

(51) Int. Cl. A61C 3/00

(52) U.S. Cl. 433/24

(57) ABSTRACT

The present invention provides methods for accelerating orthodontic tooth movement and for treating relapse. The orthodontic methods comprise applying force to reposition teeth and administering a tissue remodeling and/or an angiogenic substance to the periodontal tissue surrounding the teeth to be moved. The substance may be delivered before, during, or after the teeth are moved, and the substance may be selectively applied only to those teeth undergoing movement at any particular time. The substance may be applied from the dental repositioning appliance or may be applied separately, either locally or systemically. Orthodontic kits are also encompassed by the instant invention.

This application is a continuation-in-part of application Ser. No. 10/695,299, filed Oct. 27, 2003, which claims the benefit of U.S. Provisional Application No. 60/423,026, filed Nov. 1, 2002, the full disclosures of which are incorporated herein by reference.

### BACKGROUND OF THE INVENTION

1. Field of the Invention

The present invention relates generally to medical methods and systems. More particularly, the present invention relates to methods and systems for facilitating, accelerating, and stabilizing tooth movement before, during and after orthodontic procedures.

Orthodontic procedures suffer from four major problems. First, the braces or other appliances which effect the tooth movement must be worn for long periods of time. Second, even after a successful orthodontic treatment, the teeth often relapse towards their original positions once the braces or other treatment appliances are removed. Third, the mechanically induced movement of teeth can cause significant discomfort to the patient. Fourth, the wearing of braces is esthetically displeasing, uncomfortable, and compromises oral hygiene. While recently introduced clear plastic visible “aligners” largely overcome the latter problems, such aligners are not suitable for all patients. Moreover, the aligners do not reduce treatment time, do not reduce the risk of relapse, and do not lessen the pain associated with tooth movement in the jaw.

For these reasons, it would be desirable to provide improved orthodontic technologies for moving teeth which overcome at least some of the problems noted above. In particular, it would be desirable to provide orthodontic methods and systems which can reduce the time necessary to effect a desired tooth movement, which can reduce the pain associated with tooth movement, which can reduce the tendency of teeth to relapse to their original positions after the orthodontic treatment is stopped, and/or which can reduce the time in which unsightly braces need to be worn.

2. Description of Background Art

Nicozisis et al. (2000) Clin. Orthod. Res. 3:192-201, describe experiments which demonstrate the presence of endogenous relaxin in cranial tissue of mice and speculate that relaxin may be used as an adjunct to orthodontic or surgical therapy to promote manipulation of sutural tissues or affect stability. The application of electrical current to stimulate bone growth and remodeling in orthodontic procedures is described in U.S. Pat. Nos. 4,854,865; 4,519,779; and 4,153,060. Appliances for local and systematic drug delivery to the gingival tissues are described in U.S. Pat. Nos. 6,159,498, 5,633,000; 5,616,315; 5,575,655; 5,447,725; 5,294,004; 4,959,220; 4,933,183; 4,892,736; 4,685,883; and Re. 34,656. Polymeric shell appliances for repositioning teeth are described in U.S. Pat. No. 5,975,893. The full disclosures of each of the above publications and U.S. patents are incorporated herein by reference.

### BRIEF SUMMARY OF THE INVENTION

The present invention provides improved methods and systems for repositioning teeth in patients, including orthodontic tooth movement. In addition, the present invention provides improved methods and systems for stabilizing teeth which have already been repositioned in order to reduce or eliminate the tendency of the repositioned teeth to relapse, i.e., move back toward their prior positions. Furthermore, the present invention provides orthodontic kits. The methods for repositioning teeth comprise applying force to at least one tooth, and typically to more than one tooth and/or to different teeth over time, in the jaw of the subject (e.g., a patient). For both repositioning or stabilizing, tissue remodeling and/or treating relapse an angiogenic substance is administered to the patient to promote remodeling of the periodontal tissue surrounding the root(s) of the tooth or teeth to be moved. Preferred substance(s) will bind to and activate the relaxin receptor in the tissues which anchor the teeth or other craniofacial structures. Most preferred is relaxin or an analog or mimetic thereof which combines tissue remodeling activity with angiogenic activity. Analogs include peptides, oligomers, fragments, and the like which comprise the active region of native relaxin. Mimetics of relaxin include small molecule drugs, typically below 2 kD, designed to mimic the activity of native relaxin. Alternatively, substance(s) with predominantly angiogenic activity could be selected, such as VEGF, bFGF, estrogen, nitric oxide (NO), naltrexone, or the like. Further alternatively, collagenases or other tissue-softening enzymes could be utilized to promote periodontal tissue remodeling according to the present invention. In some instances, it may be desirable to combine two or more tissue remodeling and/or angiogenic substance(s) having differing activities. In other instances it may be desirable to deliver different tissue remodeling and/or angiogenic substance(s) at different times during the orthodontic treatment and/or to different regions of the periodontal tissue.

One aspect of the present invention provides a method for treating relapse in a subject, the method comprising optionally applying force to at least one tooth in a jaw of the subject, and administering at least one tissue remodeling and/or an angiogenic substance to the subject to promote remodeling of periodontal tissue surrounding a root of the tooth, wherein the method results in at least 10% less relapse in the subject compared to treatment with a placebo. In one embodiment, the method results in at least 10% less rotational relapse in the subject compared to treatment with a placebo. In another embodiment, the method results in at least 10% to 40% less relapse (e.g., rotational relapse) in the subject compared to treatment with a placebo. In another embodiment, the method results in at least 40% to 80% less relapse (e.g., rotational relapse) in the subject compared to treatment with a placebo. In yet another embodiment, the method results in about 10%-100% less relapse (e.g., rotational relapse) in the subject compared to treatment with a placebo. Preferably, the substance is relaxin or an analog or mimetic thereof. Relaxin can be administered, for example, locally or systemically. In this method, the substance can be administered before the force is applied, while the force is applied, and/or after the force is applied. Preferably, the force is applied over a continuous time period. Generally, force can be applied in a variety of ways, for example, providing the subject with a removable appliance (e.g., positioners, aligners, retainers, trays, etc.) or fixed appliance (e.g., brackets, bands, wires, auxiliaries, tubing, springs, coil springs, elastomeric ties, elastomaric modules, power chains, elastomeric threads, magnets, etc.)

Another aspect of the invention provides a method for accelerating orthodontic tooth movement in a subject, the method comprising applying force to at least one tooth in a jaw of the subject, and administering at least one tissue remodeling and/or an angiogenic substance to the subject to promote remodeling of periodontal tissue surrounding a root of the tooth, thereby accelerating said orthodontic tooth movement. Preferably, the substance is relaxin or an analog or mimetic thereof and can be administered, for example, locally or systemically. Similarly, in this method, the substance can be administered before the force is applied, while the force is applied, and/or after the force is applied. Preferably, the force is applied over a continuous time period. Further, force can be applied by providing the subject with a removable or fixed appliance (supra) or other methods.

The term “placebo” refers to a drug with no active ingredient, i.e., an inactive substance or treatment that looks the same as, and is given the same way as, an active drug or treatment being tested. The effects of the active drug or treatment are compared to the effects of the placebo.

The term “relapse” refers to the movement of teeth back to their original position. This includes all types of movement such as tipping, rotations, extrusions, intrusions, bodily movement, crowded up again/broken interproximal contacts, spaces opening, intruding back up after being pulled down, etc. A relapse of space opening may occur after the closure of an extraction space due to the compression of the gingiva. When looking at relapse it is possible to measure the lower anterior cuspid to cuspid using the irregularity index (see below) and to measure the crowding of the teeth (i.e., how much mesial-distal overlapping there is between contact points, usually measured in millimeters). Orthodontic rotation usually refers to motion around the long axis of the tooth. Orthodontically rotated teeth have a tendency to relapse (i.e., rotational relapse). The tendency of rotated teeth to relapse after treatment following retention is partially because of the supracrestal fibers which are stretched during rotational correction and which remodel extremely slowly. The elastic supracrestal fibers can exert forces capable of displacing a tooth over one year, or more, following orthodontic appliance removal. For a detailed description of the various types of orthodontic tooth movement, see William R. Proffit, Contemporary Orthodontics (1999), Chapter 18, Elsevier Science, which is incorporated herein by reference.

Another aspect of the invention provides an orthodontic kit which comprises a structure mountable on or over at least a portion of at least one tooth in a jaw of a subject, wherein the structure applies force to at least one tooth in the jaw; a tissue remodeling and/or an angiogenic substance capable of remodeling the periodontium (e.g., gingiva, periodontal ligament (PDL), bone) near a root of the tooth; and instructions for delivery of the substance to the subject. The instructions can be provided with the kit or separately. In one embodiment, the structure is mountable over at least a portion of at least two teeth. The structure can be selected from a variety of appliances such as positioners, aligners, retainers, trays, brackets, bands, wires, auxiliaries, tubing, springs, coil springs, elastomeric ties, elastomaric modules, power chains, elastomeric threads, magnets and the like. The structure can be positioned over a portion of the jaw, over the entire jaw, over at least two teeth in the jaw, over all teeth in the jaw, or combination or variations thereof. Preferably, the substance is relaxin or an analog or mimetic thereof. As such, the substance can be stored in a separate container or within the structure itself. The structure may comprise a porous material (e.g., chamber) which releases the substance at a controlled rate over time.

The term “relaxin” means human relaxin, including intact full length relaxin or a portion of the relaxin molecule that retains biological activity (as described in U.S. Pat. No. 5,023,321, preferably recombinant human relaxin (H2)) and other active agents with relaxin-like activity, such as Relaxin and portions that retain biological activity as Relaxin-like factor (as described in U.S. Pat. No. 5,911,997 at SEQ ID NOS: 3 and 4, and column 5, line 27-column 6, line 4), relaxin analogs and portions that retain biological activity (as described in U.S. Pat. No. 5,811,395 at SEQ ID NOS: 1 and 2, and column 3, lines 16-40), and agents that competitively displace bound relaxin from a receptor. Relaxin can be made by any method known to those skilled in the art, for example, as described in any of U.S. Pat. Nos. 5,759,807; 4,835,251 and co-pending U.S. Ser. Nos. 07/908,766 (PCT US90/02085) and 08/080,354 (PCT US94/0699).

The tissue remodeling and/or angiogenic substance(s) will be delivered at a delivery rate and a total dosage which are selected to facilitate tooth repositioning and tissue remodeling. Typically, the dosage rates will be in the range from 1 ng to 500 μg per day, usually from 10 ng/day to 20 μg/day, preferably from 20 ng/day to 10 μg/day. When treating relapse, relaxin can be administered, for example, locally. Local administration includes, but is not limited to, topical delivery of relaxin on gingival tissue near the tooth and gingival injection. Topical delivery can be accomplished, for example, by releasing relaxin from a controlled release device engaged against the gingival tissue or by spreading a fluid substance over the gingival tissue. For example, relaxin can be topically delivered at about 50 μg or more per treated tooth, such that enough relaxin is delivered to all the proper tissues. As such, relaxin can be topically delivered by spreading a fluid substance over the gingival tissue or by supplying relaxin to the gingival tissue via a patch. Local administration can also be accomplished via gingival injection. In one embodiment, relaxin is injected into gingival tissue at about 100 ng to 1 mg per treated tooth. In another embodiment, relaxin is injected into gingival tissue at 50 μg per treated tooth. Relaxin can also be locally administering via an implantable pump. For example, with an implantable pump, relaxin can be delivered at a rate of administration of about 10 μg per hour which may last for about 8 hours. Relaxin may also be administered systemically which includes administration of relaxin to the blood stream. The dosage and other aspects of any type of relaxin delivery may be adjusted from time-to-time in response to the effectiveness of treatment, such as the resistance of a particular tooth or group of teeth, where the dosage might be increased if resistance is not sufficiently reduced in response to an initial dosage. When accelerating orthodontic tooth movement, relaxin may also be administered locally or systemically.

The substance(s) may be delivered at any point during the orthodontic treatment where tooth repositioning and/or tissue remodeling may be promoted. For example, the substance(s) may be applied prior to any application of force intended to move the teeth. Additionally or alternatively, the substance(s) may be applied during all or any portion of the time during which force is being applied to move the teeth. Further additionally or alternatively, the substance(s) may be applied after the teeth have been repositioned to a final desired configuration. In the latter case, application of the substance(s) may be particularly effective for promoting tissue remodeling in order to reduce the risk of relapse. In such instances, the substance(s) may be delivered using retainers or other appliances intended to help maintain the teeth in their desired final configuration. When being delivered to inhibit relapse, the remodeling and/or angiogenic substance(s) may be delivered for a limited period of time in a limited period before and/or immediately following the end of the orthodontic procedure or may be delivered continuously or periodically for long periods of time or indefinitely following the end of the orthodontic procedure. For example, the substance(s) may be delivered to some or preferably all of the regions of the gingiva where teeth have been moved in order to promote stabilization and remodeling of the tissue, usually over a period of one to eight weeks, more usually two to six weeks prior to the end of treatment.

The teeth may be repositioned by any conventional orthodontic appliance intended for applying force to move teeth. In particular, the present invention is compatible with both the use of wire and bracket systems, commonly referred to as “braces,” as well as with newer systems employing removable appliances for repositioning teeth, such as the Invisalign® System (available from Align Technology, Inc., Santa Clara, Calif.) and the “Red White & and Blue Retainer” system (available from Sybron Dental Specialties, Inc., Irvine, Calif.). The present invention will also be useful with dental “positioners” which are elastomeric appliances having pre-formed tooth-receiving cavities where the patient bites into the elastomeric appliance in order to force tooth movement. The present invention may be used with dental retainers which are polymeric shell appliances typically used to maintain a final, desired tooth configuration and prevent relapse (e.g., the Essix™ retainer or appliance by Raintree Essix, LLC). When used with dental repositioning appliances of any type, the application of the tissue remodeling and/or angiogenic substance(s) according to the present invention will usually both facilitate tooth movement by modifying the tissue structures within the periodontal tissue which anchor the teeth and also promoting tissue remodeling which allows such tissue structures to accommodate the repositioned teeth with less tendency toward relapse. The present invention may be used with any one or more of the following appliances including, but not limited to positioners, aligners, retainers, trays, brackets, bands, wires, auxiliaries, tubing, springs, coil springs, elastomeric ties, elastomeric modules, power chains, elastomeric threads, magnets and implants (including microimplants). For example, implants and micro implants can be used in orthodontics to act as anchorage means. As such, elastomeric threads and/or chains and coil springs are tied from these implants to one or more teeth in order to move the teeth. The implants provide anchorage and do not tax the posterior teeth when retracting anterior teeth. The implants also provide anchorage for intruding teeth that are super-erupted. Additionally, implants can be surface coated for the purpose of improving their oseo-integration (fusion to alveolar bone).

The substance(s) of the present invention may be applied and administered in a wide variety of ways. Most simply, the substance(s) could be “painted” or otherwise topically applied to the patient's gingiva using a conventional single-use applicator such as a swab, brush, syringe, or the like. The substance(s) may be prepared in a conventional form of topical composition, such as a gel, cream, ointment, or other fluid or liquid substance. Alternatively, the substance(s) could be administered by injecting into the periodontal tissue. Additionally, the substance(s) could be delivered using a patch or other appliance which is worn on the teeth or gingiva, optionally being formed as part of the same appliance which is used to move the teeth, e.g., a bracket or removable appliance (e.g., shell applicance) or retainer. In such instances, the substance(s) may be incorporated into conventional reservoirs (e.g., drug reservoir) which both maintain a supply of the substance(s) and which release the substance(s) at a controlled rate, over time, to target sites on the gingiva. Suitable drug delivery structures for delivering the substance(s) to the patient gingiva are described in the patent and medical literature, see, e.g., U.S. Pat. Nos. 6,159,498, 5,575,655; 5,194,003; 4,933,182; and 4,685,883, the full disclosures of which are incorporated herein by reference.

In some instances, it may be desirable to provide for enhanced penetration of the substance(s) into the gingiva. For example, the substance(s) could be formulated with tissue penetration or permeation enhancers, such as dimethylsulfoxide (DMSO). Alternatively or additionally, the substance(s) can be delivered while applying energy in a manner to promote tissue penetration, including the application of an electric current in order to achieve electroporation or iontophoresis, and/or the application of ultrasound energy. The currents needed to provide for electroporation are relatively low, typically around 0.1 mA or lower can be provided by batteries contained within the delivery structure or alternatively by external structures which are periodically applied to the gingiva or appliances present over the gingiva. For example, the methods of the present invention may comprise applying an electric current to the periodontal tissue surrounding the root of a tooth, wherein the applied current has a current density in the range from from 0.5 μA/mm² to 6 μA/mm². Similarly, ultrasound-enhanced substance delivery can be effected by transducers incorporated into the delivery appliances and/or provided by external appliances. Suitable ultrasound conditions are from 20 kHz to 100 kHz at energy levels of one to ten J/cm².

A particular advantage of the present invention is that particular teeth can be treated with the substance(s) while other teeth in the same jaw remain untreated. In this way, those teeth which are to be moved at any point during the course of orthodontic treatment may be “relaxed” and prepared for movement while other teeth which are needed as “anchor teeth” remain untreated. In this way, the wire and bracket system, removable aligner, or the like, may be anchored on those teeth which have not been treated with the substance(s), while those teeth which are intended to be moved may be treated and more readily moved. Of course, during a normal orthodontic treatment, different teeth will be targeted for movement at different times. The present invention allows only those teeth which are intended to be moved at any particular time to be treated at that time while other teeth in the dentition remain untreated during that time and available as anchor teeth for performing the orthodontic treatment.

The present invention may also advantageously be combined with other orthodontic treatment protocols, such as electroosteogenesis where a small electrical current is applied to the gingiva or jaw to stimulate the tissues. The combination of the substance(s) with such electroosteogenesis could provide tooth movement which may be improved over that achieved with either approach alone. Moreover, the application of the electric current might act to provide “electroporation” and enhance the uptake of the substance(s) into the periodontal tissues, as described above.

In a further aspect of the present invention, improved orthodontic treatment methods are provided. The orthodontic treatment methods are of the type where at least one tooth in a patient jaw is repositioned. The improvement comprises administering at least one tissue remodeling and/or an angiogenic substance to the patient before, during, or after the force has been applied. The preferred aspects of this method are generally the same as described above.

The present invention still further provides oral delivery appliances comprising a structure and a tissue remodeling and/or an angiogenic substance(s). The structure is mountable on or over at least a portion of a patient gingiva, and the substance(s) is carried by the structure so that said substance(s) is release into at least a region of the gingiva while the structure is mounted on or over the gingiva. Typically, the delivery appliance mounts over the gingiva of an entire jaw, but in some instances it may mount over the gingiva of less than the entire jaw. Typically, the structure will include at least a portion which engages or mounts over the gingiva adjacent the roots of the target teeth, typically from one to twelve teeth, usually from one to six teeth, often from one to five teeth, and sometimes only a single tooth. The appliance may be in the form of a patch which adheres to the gingiva, a shell which is removably placeable over the teeth in the gingiva, or the like. The use of patches for delivery of the substance(s) may be particularly advantageous since the patches can be cut to size in order to control dosage and/or delivery area to the gingiva. Such modified patches may be applied or adhered directly to the gingiva or alternatively may be positioned beneath a retainer which is worn to maintain the positions of the teeth. When wire and bracket orthodontic appliances are used, the delivery appliance may be formed to mount on the wire or onto the bracket, may be incorporated as part of the bracket or wire, or may be some combination thereof. The relaxin or other tissue remodeling and/or angiogenic substance may be incorporated into the oral delivery appliance in a variety of ways. Most commonly, the relaxin will be in a liquid, gel, or other releasable form which is incorporated into a time-release structure to apply the substance to the gingiva at a desired dosage rate. For example, the substance(s) may be incorporated into a porous structure and/or in a reservoir which is covered by a porous structure. In either case, the porous structure acts as a rate-controlling membrane or barrier to achieve the desired delivery rate. Alternatively, the substance(s) may be present in a biodegradable matrix which degrades in the oral environment over time to achieve a desired release rate of the substance. Suitable degradable substances include polymers, such as glycolic acid polymers and related materials.

In a still further aspect of the present invention, topical oral compositions comprise a carrier and a tissue remodeling and/or an angiogenic substance(s). The carrier is of the type which may be topically applied to a patient's gingiva, typically being in the form of a gel, cream, ointment, microemulsion or other liquid. The tissue remodeling and/or an angiogenic substance(s) may be any of the substance(s) listed above. The composition may be provided in any conventional applicator, such as a tube, syringe, bottle, or the like, and will be maintained in a sterile condition within the applicator.

### BRIEF DESCRIPTION OF THE DRAWINGS

FIG. 1 illustrates an oral tissue remodeling and/or an angiogenic substance(s) delivery appliance constructed in accordance with the principles of the present invention, in the form of a patch.

FIG. 2 is a cross-sectional view taken along line 2-2 of FIG. 1.

FIG. 3 illustrates the use of the patch of FIG. 1 in a first exemplary protocol according to the present invention.

FIG. 4 illustrates the use of the patch of FIG. 1 in a second exemplary protocol according to the present invention.

FIG. 5 illustrates the use of a polymeric shell appliance for repositioning teeth and delivering a tissue remodeling and/or an angiogenic substance(s) according to the principles of the present invention.

FIG. 6 is a photograph illustrating the section of the incisor which was excised for use in the push out testing described in the Experimental Section.

FIG. 7 is a photograph illustrating the test equipment used for the push out testing.

FIG. 8 is a graph showing the results of the push out testing.

FIG. 9 is a photograph showing how the tooth wiggle testing was performed.

FIGS. 10-13 are graphs showing the results of the pull out testing.

FIG. 14 is a graph showing the results of the tooth wiggle testing.

FIG. 15 illustrates the results of the dose response testing.

FIG. 16 depicts landmark metal pins in the bone of the roof of the mouth and in the incisors of a rat (e.g., the 1st molar is pulled forward by an appliance connecting the 1st molar and incisor).

FIG. 17 shows a graph of the data from two relaxin treated groups (pump vs. injection). The data from the two groups was combined and compared to vehicle control.

FIG. 18 shows a diagram of the appliance used in a dog.

FIG. 19 shows an activated appliance in a dog.

FIG. 20 illustrates a procedure called fiberotomy in which the gingival fibers attached to the tooth are cut down to the alveolar bone.

FIG. 21 shows a graph that compares individual animals from a gingival injection group (i.e., injected with relaxin) to a group treated with fiberotomy (positive control) and a negative control group. As shown, five out of eight animals provided similar results as the fiberotomy group while three out of eight animals were above the controls. (See legend on FIG. 23.)

FIG. 22 shows a graph that compares the mean of the gingival injection group from FIG. 21 with the fiberotomy group (positive control) and the negative control group. As shown, the positive control group had significantly less relapse than the negative control group. The group injected with relaxin showed results intermediate between the negative and positive control groups.

FIG. 23 shows a reevaluation of FIG. 22. The data were plotted as medians instead of means (i.e., as shown in FIG. 22). This reduces the influence of outliers and allows trends to be seen better.

### DETAILED DESCRIPTION OF THE INVENTION

The present invention provides improved and facilitated orthodontic treatment by delivering tissue remodeling and/or an angiogenic substance(s) to periodontal tissue in which the teeth to be moved are rooted or anchored. As used hereinafter, “periodontal tissue” or “periodontium” will refer to the connective tissue within the periodontal tissues, specifically including the gingiva and periodontal ligaments (PDL) which anchor the teeth in the bone. The periodontium also includes the bone near the root of a tooth. The application of the tissue remodeling and/or an angiogenic substance(s) to the periodontium will both loosen the tissue and ligaments as well as promote remodeling of the tissue during and after orthodontic treatment.

The tissue remodeling and/or angiogenic substance(s) may be delivered to the periodontal tissue in a variety of ways, including local administration. For example, the substance can be administered through topical delivery by spreading a fluid substance over the gingival tissue, topical delivery via a patch, topical delivery to the gingival tissue near the tooth from a controlled release device engaged against the gingival tissue, topical delivery via an implantable pump, gingival injection, and the like, continuously, periodically, and combinations thereof. Thus, topical delivery may be achieved using a conventional surface applicator, such as a brush, swab, syringe, squeeze tube, sponge, or other similar device or by using various controlled release devices, such as retainers, patches, orthodontic brackets and wires, and other appliances (e.g., a removable or fixed appliance, that comprises a reservoir which releases a substance to gingival tissue, such as positioners, aligners, retainers, trays, brackets, bands, wires, auxiliaries, tubing, springs, coil springs, elastomeric ties, elastomaric modules, power chains, elastomeric threads, magnets and the like) which may be positioned on or over the teeth and which have been modified in order to release the substance(s) to the gingiva. In some cases, it will be desired to deliver the drug into the gingival margin which is the line or groove along the gingiva-tooth interface. Substances may be applied as part of formulations which are delivered over the gingiva and/or into the sulcus. In some instances, it may be desirable to plant small substance delivery structures directly into the sulcus in a manner analogous to the delivery of antibiotics using systems (e.g., the PerioChip® available from Dexcel Pharma, Inc.). The following specific examples of patches and structures for delivering the tissue remodeling and/or angiogenic substance(s) of the present invention are meant to be exemplary and not limiting.

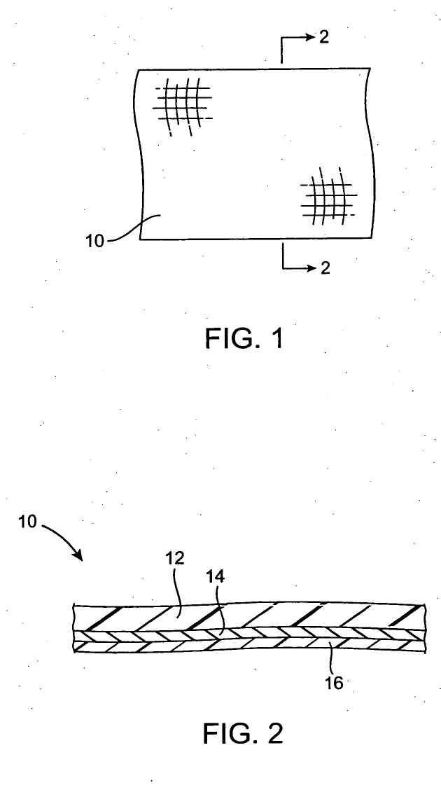

Referring to FIGS. 1 and 2, the substance(s) may be applied in a variety of ways, including using a patch 10 which typically comprises a reservoir layer 12, a rate controlling membrane 14, and an adhesive layer 16. A patch 10 may be cut into strips, smaller patches, or the like, and may be applied to the gingiva in order to effect topical delivery of the substance(s) from the reservoir into the tissue.

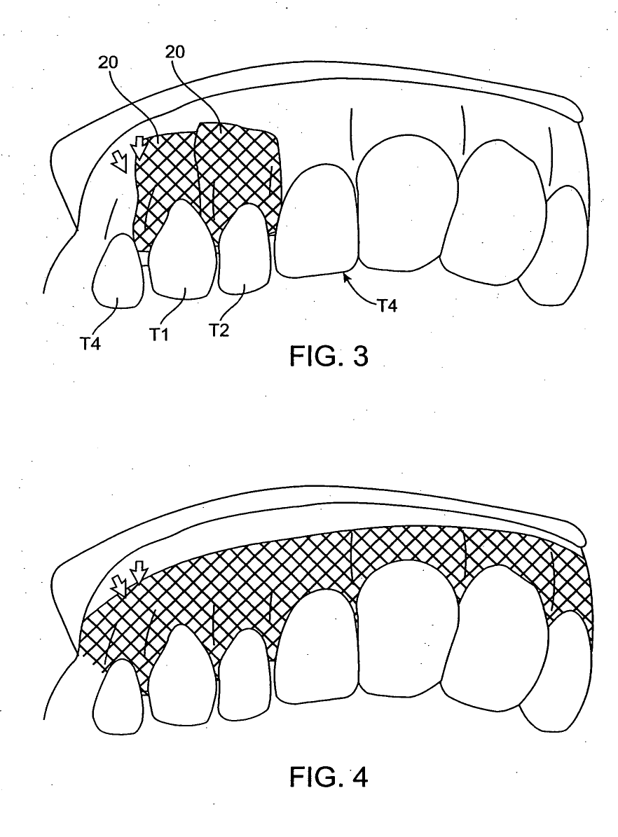

As shown in FIG. 3, the patch 10 of FIG. 1 may be cut into smaller strips or pieces 20 which may be placed over the gingiva overlying individual teeth. In this way, the teeth T1 and T2, for example, may be treated to facilitate movement and promote periodontal tissue remodeling, according to the present invention, while adjacent teeth T3 and T4, as well as other non-treated teeth, remain available as anchor teeth for effecting orthodontic treatment, typically using conventional wire and bracket systems (not shown). In FIG. 3B, the positioning of the patches 20 over the roots of the teeth is shown.

In FIG. 4, a continuous strip 30 of the patch material 10 is shown placed over the gingiva of eight adjacent teeth. The strip 30, of course, could extend around the entire gingiva of one jaw. In this way, the substance(s) can be delivered to all teeth at once. Such treatment might be preferred, for example, for treating teeth after the teeth have reached their final position in order to promote tissue remodeling. Alternatively, the strip 30 could be configured so that the tissue remodeling and/or an angiogenic substance(s) are released only from particular locations on the strip to treat individual target teeth, achieving the same type of treatment as shown in FIG. 3. Although patch and strip placement in FIGS. 3 and 4 is shown only on the labial side of the gingiva, the strips could be placed additionally or alternatively on the lingual side of the gingiva.

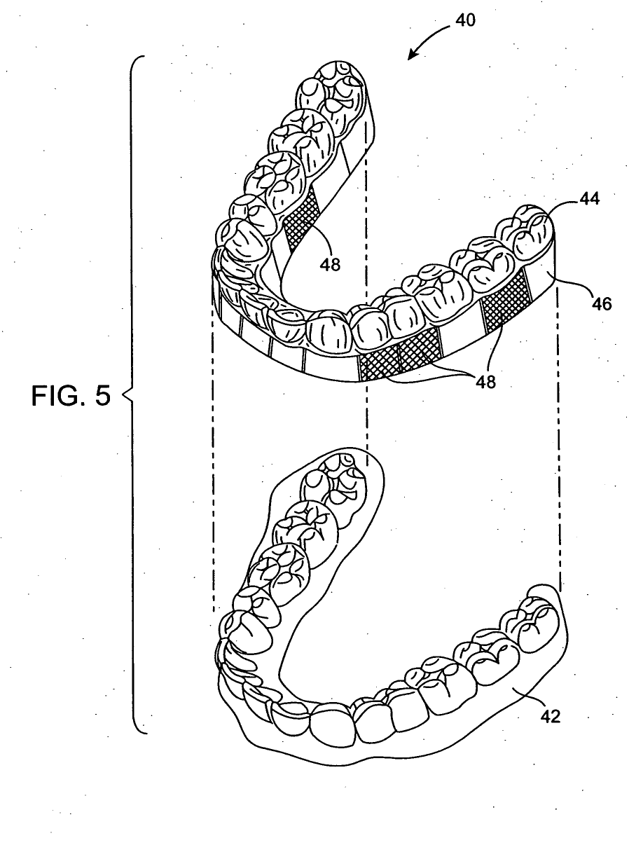

Referring now to FIG. 5, a dental retainer or aligner 40 is shown for placement over the dentition of a single jaw 42. A crown portion 44 of a retainer/aligner 40 is configured to be removably positionable over the teeth, while a skirt portion 46 is configured to lie over the gingiva, usually both the labial and lingual sides of the gingiva. The skirt is configured to retain and release the tissue remodeling and/or an angiogenic substance(s), either over its entire surface or over selected regions 48 as shown. In this way, the substance(s) may be selectively delivered to individual teeth or to the entire dentition in a single jaw, depending on the particular treatment protocol.

The orthodontic kits of the instant invention apply to acceleration of orthodontic tooth movement and treatment of relapse. The kits include a structure that applies force to at least one tooth in the jaw. The optimal force levels for orthodontic tooth movement are just high enough to stimulate cellular activity without occluding blood vessels in the PDL. Generally, tooth movement is more efficient when necrosis of the PDL is avoided. The PDL response is not simply determined by how much force is applied, but more specifically, by the force applied per unit area (i.e., pressure). The distribution of force (and the pressure) differs with different types of tooth movement. For example, the simplest form of orthodontic tooth movement is tipping. Tipping occurs when a single force is applied against the crown of a tooth such that the tooth rotates around its center of resistance (i.e., a point located about halfway down the root). The force that is used to tip teeth should be kept low, about 35-60 gm, and should preferably not exceed 50 gm. When two forces are applied simultaneously to the crown of a tooth, then bodily movement or translation may occur (i.e., the root apex and crown move in the same direction the same amount). In comparison to tipping, twice as much force is required for bodily movement. Thus, the required force for bodily movement is about 70-120 gm. Other types of orthodontic tooth movement include root uprighting (50-100 gm); rotation (35-16 gm); extrusion (35-60 gm); and intrusion (10-20 gm). For a detailed description of the various types of orthodontic tooth movement, see William R. Proffit (supra) which is incorporated herein by reference.

The orthodontic kit of the invention includes a structure that is mountable on or over at least a portion of at least one tooth in a jaw of a subject. The structure applies force to at least one tooth in the jaw (supra) and can be selected from a variety of appliances such as positioners, aligners, retainers, trays, brackets, bands, wires, auxiliaries, tubing, springs, coil springs, elastomeric ties, elastomaric modules, power chains, elastomeric threads, magnets and the like. The choice of the particular structure, i.e., the functional and/or corrective appliance, may depend on the subject and type and length of the treatment. Generally, the structure of the invention can be positioned over a portion of the jaw, over the entire jaw, over at least two teeth in the jaw, over all teeth in the jaw, or combination or variations thereof. In one embodiment, the structure is mountable over at least a portion of at least two teeth. In some instances, the structure may include a porous material (e.g., chamber) which releases a remodeling and/or an angiogenic substance at a controlled rate over time. Thus, the kits further contain a tissue remodeling and/or an angiogenic substance capable of remodeling the periodontium (e.g., gingiva, PDL, bone) near a root of the tooth. Preferably, the substance is relaxin or an analog or mimetic thereof. As such, the substance may be stored in a separate container or within the structure itself. The kits may include instructions for delivery of the substance to the subject. The instructions can be provided with the kit (e.g., instruction material provided in a package together with the kit) or separately (e.g., instruction material provided via a separate booklet, via a video or DVD, via remote access such as the Internet, etc.).

The kits of the instant invention are useful for treating a variety of orthodontic problems, including malocclusion (i.e., the improper alignment of teeth) and relapse (i.e., the movement of teeth back to their original position). There are many different types of malocclusions as shown below. However, the instant invention is not limited to these examples. Incisor irregularity is expressed as the irregularity index (i.e., the total of the millimeter distances from the contact point on each tooth to the contact point that it should touch). A space between adjacent teeth is called a diastema. During childhood, a maxillary midline diastema is relatively common. Howerver, a midline diastema that is greater than 2 mm rarely closes spontaneously with further development. A posterior cross bite exists when the maxillary posterior teeth are lingually positioned relative to the mandibular teeth. Overjet is defined as a horizontal overlap of the incisors. Normally, the incisors are in contact, with the upper incisors ahead of the lower by only the thickness of the upper edges (i.e., 2-3 mm overjet is the normal relationship). If the lower incisors are in front of the upper incisors, the condition is called reverse overjet or anterior crossbite. Another form of malocclusion is overbite. Overbite is defined as vertical overlap of the incisors. Normally, the lower incisal edges contact the lingual surface of the upper incisors at or above the cingulum (i.e., there is normally a 1-2 mm overbite). In a condition called open bite, there is no vertical overlap, and the vertical separation is measured (see Proffit, supra). Since only 34 percent of American adults have well-aligned lower incisors, there is a constant need for improved orthodontic methods and kits to correct improperly aligned teeth. The instant invention meets this need.

The following examples are offered by way of illustration, not by way of limitation.

### Experimental

Four studies are presented, one examining properties of the periodontal and gingival tissues to relaxin; a second one on dose finding; a third one on orthodontic tooth movement; and a forth one on prevention of relapse.

I. In vivo Studies of the Periodontal Ligament

A rat model was utilized because the rat has been historically used for many orthodontic studies. There were five animals per treatment group. Rats were treated for 1 or 3 days with human relaxin (H2 gene product) or vehicle control (Table 1 below). Relaxin or control vehicle was administered via Alzet implanted minipumps. In addition, relaxin treated rats received a 0.5 mg bolus injection (1.43 mg/kg) of relaxin at the time pumps were placed.

TABLE 1

| Days of Treatment | Control | Relaxin |
|---|---|---|
| 1 Day | C1 (n = 5) | R1 (n = 5) |
| 3 Days | C3 (n = 5) | R3 (n = 5) |

The jaws were collected for transport to the University of Washington for analysis. The day 1 jaws were delivered fresh, and the day 3 jaws were delivered frozen. Teeth from each treatment group were tested for “looseness” using a material testing device (MTD), and the periodontal ligament (PDL) was tested in a “push-out” test. The rest of the jaw was saved for histological analysis.

II. Objectives

These tests evaluated the ability of human relaxin (H2) to accelerate tooth movement during orthodontic procedures in a rat model. These studies examined the short term effects of relaxin on tooth looseness using circulating relaxin and a material testing device (MTD).

A. Tooth Looseness Tooth displacement measured in response to a known force was measured.

B. Push-Out Test The material properties of the PDL were measured in a material testing device to obtain force/displacement curves.

C. Histological Analysis The contralateral jaw was used for histological analysis. Staining techniques were used to visualize collagen and elastin.

III. Protocol

A. Treatment Groups

Adult male Sprague-Dawley rate (89-94 days old) were purchased from Animal Technologies, Ltd, Livermore, Calif. There were five animals per treatment group having body weights of 300-350 grams. Rats were treated for 1 or 3 days with human relaxin (H2 gene product) or vehicle control (Table 1). Relaxin or control vehicle is administered via Alzet implanted minipumps. In addition, relaxin treated rats received a 0.5 mg bolus injection (1.43 mg/kg) at the time pumps were placed.

B. Relaxin Administration

Human relaxin (H2) produced by Connetics, Corp was administered using Alzet osmotic pumps as previously described in the rat (Garber et al. (2001) Kidney Int. 59: 1184-85). Relaxin was administered at a rate of approximately 8 μg/kg/hr. This delivery rate has been shown to result in a blood concentration of approximately 150 ng/ml (Garber, Microchnik et al. 2001). To ensure relaxin levels rapidly achieved effective concentrations, rats were given a bolus subcutaneous injection of 0.5 mg relaxin at the time of pump implant. Control animals received the same volume of vehicle.

C. Animal Manipulations

Animals were euthanized with anesthesia overdose at each of the specified time intervals. Maxillae were dissected into halves. One hemimaxilla was fixed in 10% formalin for 24 hours followed by decalcification in 10% EDTA for two weeks with daily changes of the solution, dehydration in increasing concentrations of ethanol, and embedding in paraffin for immunohistochemical and histomorphometric analyses. The other hemimaxilla was fixed, decalcified and frozen for the immunohistochemical analyses. Calvarias were saved for examination of sutures by similar procedures.

D. Measuring Tooth Movement

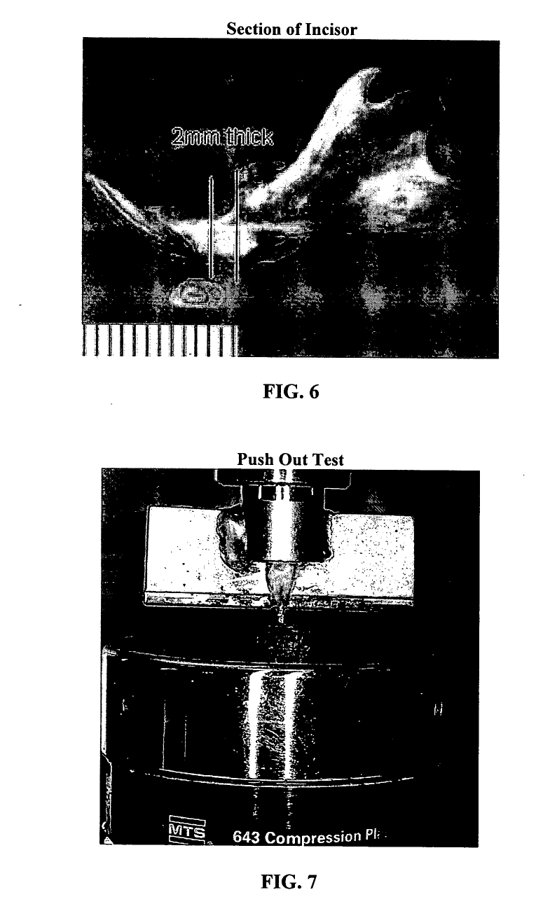

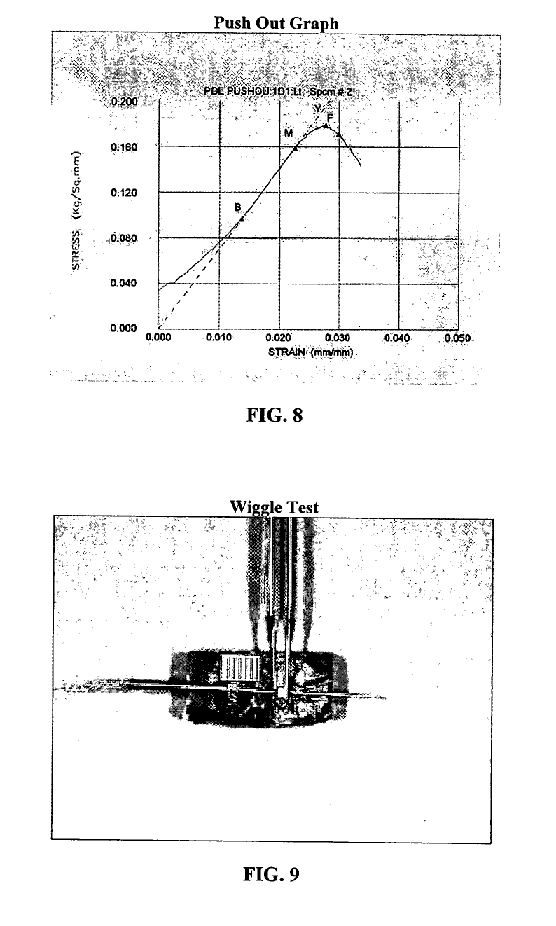

1. Push Out Test Gingival tissues were dissected away, and a 2 mm disk was cut through the alveolar bone and incisor (FIG. 6). The resulting disk had alveolar bone, periodontal ligament (PDL), tooth, and pulp and was embedded in paraffin. The embedded tissue block was loaded onto a material testing device (FIG. 7) to produce the stress-strain curve shown in FIG. 8.

$$Stress = \frac{load}{cross \text{-} sectional area} = kg \text{/} {mm}^{2}$$

$$Strain = \frac{elongation}{original length} = \% elongation$$

2. Wiggle Test The second premolar tooth was embedded in paraffin and wiggled in place (FIG. 9). The amount of movement was recorded.

The resulting amount of displacement was measured repeatedly and averaged for each specimen.

IV. Results and Analysis

A. Material Testing The material testing of the rat jaws included two different tests. These were the “push-out” test, and the “wiggle” test. Separate teeth were used for each of these tests, as explained below. The Day 1 specimens were delivered fresh while the Day 3 were frozen so are only directly comparable with the controls for that day.

1. Push-Out Test The push-out test resulted in many different parameters of a stress strain curve. Several of the more relevant parameters were selected for the following graphs.

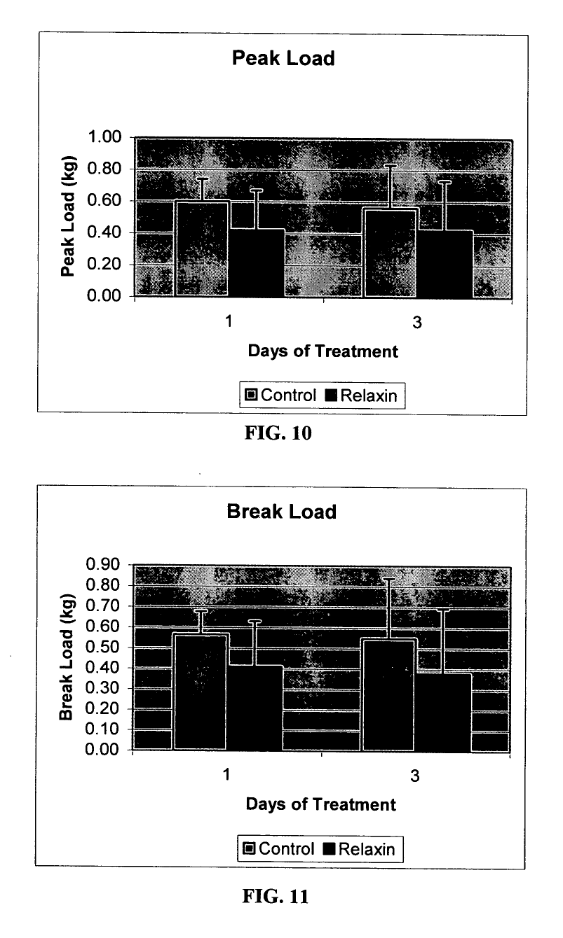

Referring to FIG. 10, peak load is a measure of the maximum load (kilograms) that the PDL can withstand before breaking. The PDL appears to be “weaker” with relaxin treatment, either at day 1 or day 3 of treatment.

Referring to FIG. 11, break load is the force in kilograms needed to break the PDL. It was observed that the force was less with relaxin treatment, indicating a softening of the ligament.

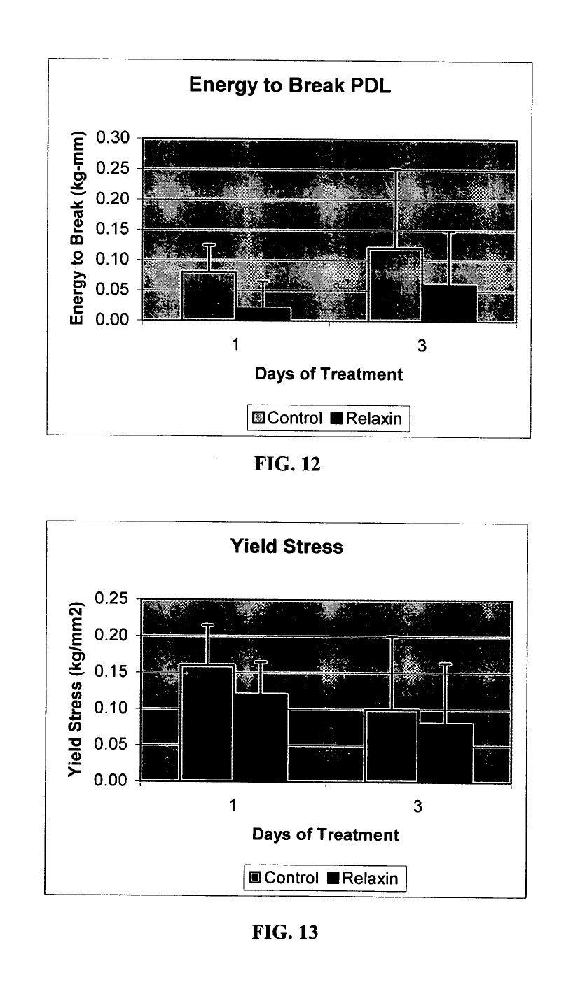

Referring to FIG. 12, energy is the area under the curve of the force needed to break the PDL. Again, relaxin resulted in less energy needed to break the PDL indicating its lessened resistance to force.

Referring to FIG. 13, yield stress is the amount of stress (kilograms/square mm) needed to cause the PDL to yield. The effect of relaxin was to lower this parameter, indicating the ligament was softer.

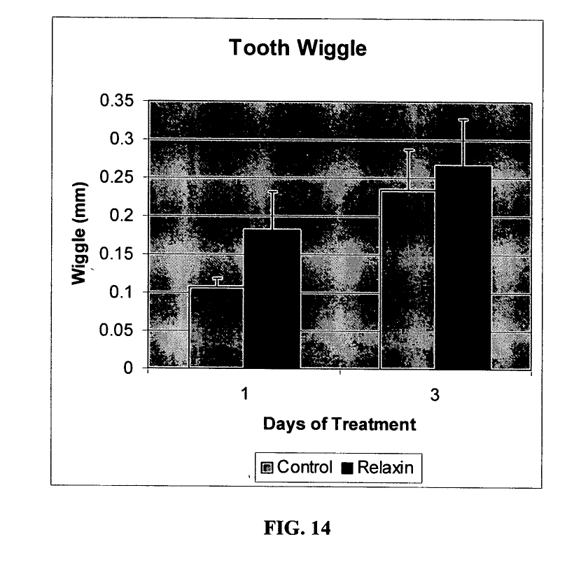

2. Tooth Wiggle Referring to FIG. 14, the tooth wiggle test demonstrated that the tooth was looser in the relaxin treated animals. This was especially prominent in the day 1 treated animals. The smaller difference seen on day 3 may be due to freezing the tissue.

B. Histological Analysis The specimens were decalcified, embedded, sectioned and strained with a variety of histological stains. The PDL and gingival connective tissue were examined for a reduction and/or reorganization in the collagen. Collagen normally has a highly regular structure, which can be observed under a microscope using polarized light. Intact collagen demonstrates a birefringence or glow which is lost upon breakdown of the collagen.

Comparison of the treated collagen with the untreated control, under polarized label, demonstrated that the relaxin had broken down the collagen. In the relaxin treated animals, the collagen fibers have been shortened and no longer have the parallel arrangement.

V. Dose Finding Experiment

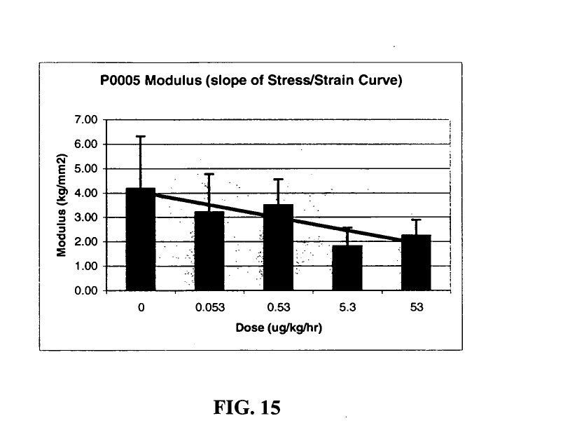

The following test helps determine an effective dose of relaxin for modification of collagen in the PDL and gingival tissues. Relaxin was administered in different doses to the rat for 5 days via Alzet subcutaneous pumps. Again the material testing device was used for measurement of the effects of relaxin. The results are shown in FIG. 15.

The modulus is the slope of the stress strain graph. This figure suggests a dose relationship of relaxin with the softening of the PDL. It appears that even the lowest dose had modest effects on the PDL, indicating that a small amount of relaxin would be effective.

VI. Summary of Data

These data demonstrate for the first time that relaxin is effective in vivo in modifying the mechanical characteristics the ligaments that hold the tooth in the jaw. Major effects appear to be on the collagen which comprises a large portion of the PDL and gingival fibers. Relaxin affects these fibers as demonstrated by histological and physical measurements. The result of this modification of PDL and gingival fibers is to accelerate tooth movement and prevent relapse. Our data on dose indicate that even small amounts of relaxin may be effective in achieving these effects.

VII. Orthodontic Tooth Movement

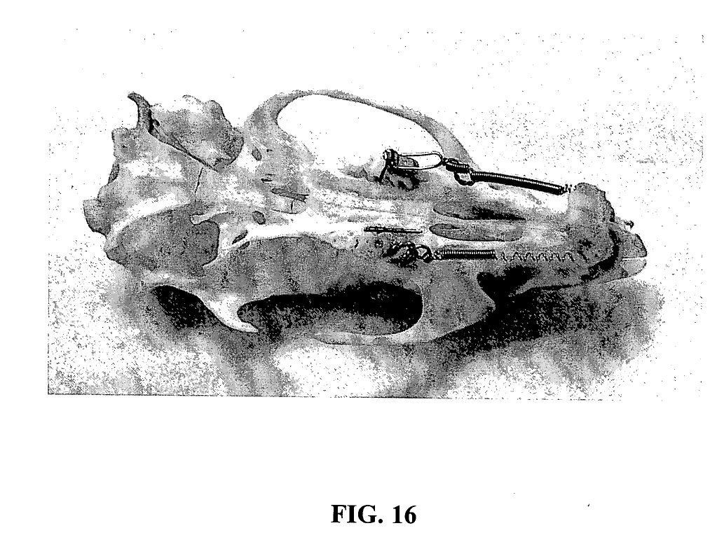

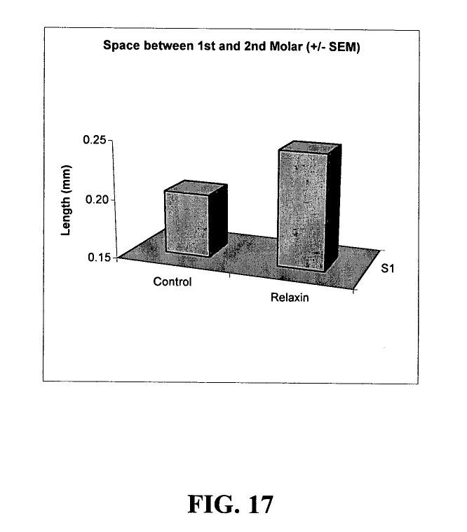

This third study demonstrates that treatment with relaxin ultimately leads to a significant increase in the rate of tooth movement. A rat model was used. Landmark metal pins were placed in the bone of the roof of the mouth and pins were installed in the incisors of the rat as shown in FIG. 16 (e.g., the 1^{st} molar is pulled forward by an appliance connecting the 1^{st} molar and incisor). This was done several days prior to the application of orthodontic appliances. A set force of 40 grams was used for activation. The animals had pumps installed or were injected with relaxin. Rats were treated for 14 days with vehicle or relaxin administered in one of two ways. One group of rats received a continuous system administration (5.3 μg/kg/hr) with an implantable pump. A second group of treated rats received a subcutaneous injection of relaxin (0.5 mg/kg) in sodium acetate buffer on day 1 and day 7 of the treatment period. The data from a dose finding study indicated that the pump supplied a steady state of about 20 ng/ml of relaxin during the experiment.

Digital photographs were taken of the molar teeth at the end of the treatment period. The distance between the 1^{st} molar, which was being orthodontically moved, and the 2^{nd} molar which was stationary was measured. This distance is a measure of the total amount the tooth moved during the 14 day period. The two relaxin treated groups (pump vs. injection) were similar and the data from the two groups was combined to result in the following graph as shown below in FIG. 17 (i.e., this graph depicts the combined relaxin treatment groups compared with vehicle control). As shown in FIG. 17, the relaxin treatment resulted in a significantly greater space between the molars in the relaxin treated animals compared to the control animals (p=0.0323). This indicates that relaxin treatment helped move the tooth further in the same amount of time than in the control animals. These results confirmed the hypothesis that relaxin would significantly increase the rate of tooth movement. In summary, the measurement of the gap between the molars was found to be significantly increased with relaxin treatment and other measurements tended in the direction of increased movement with relaxin. This strongly supports the findings that relaxin treatment with applied force can significantly speed orthodontic tooth movement.

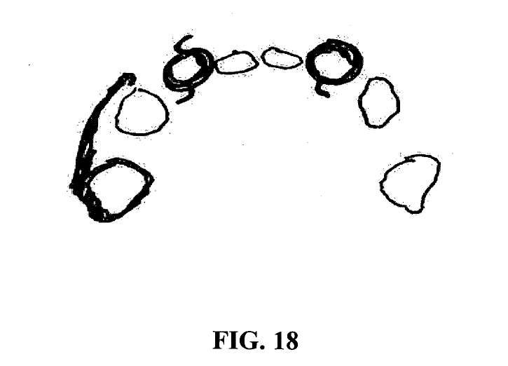

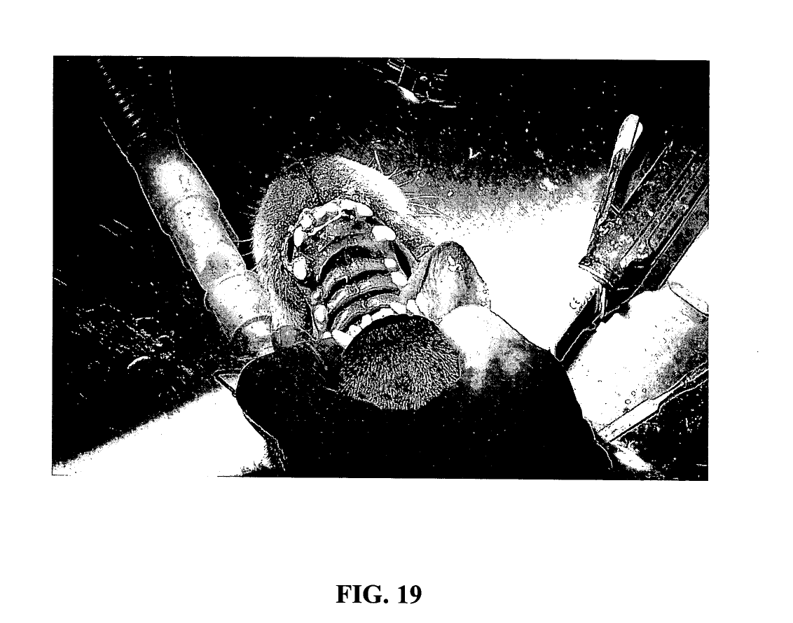

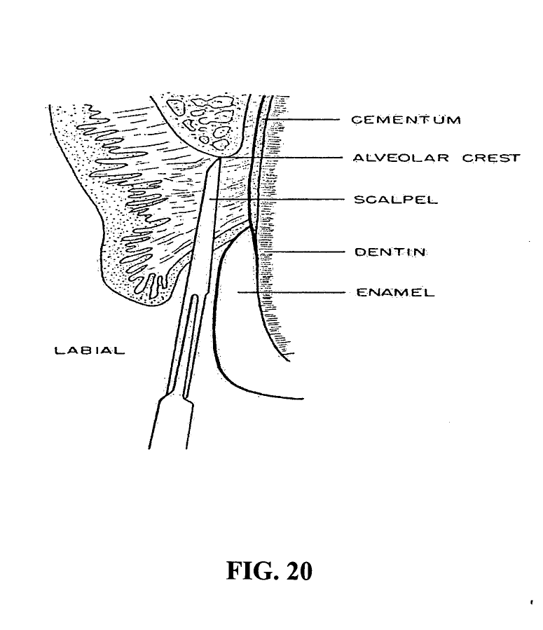

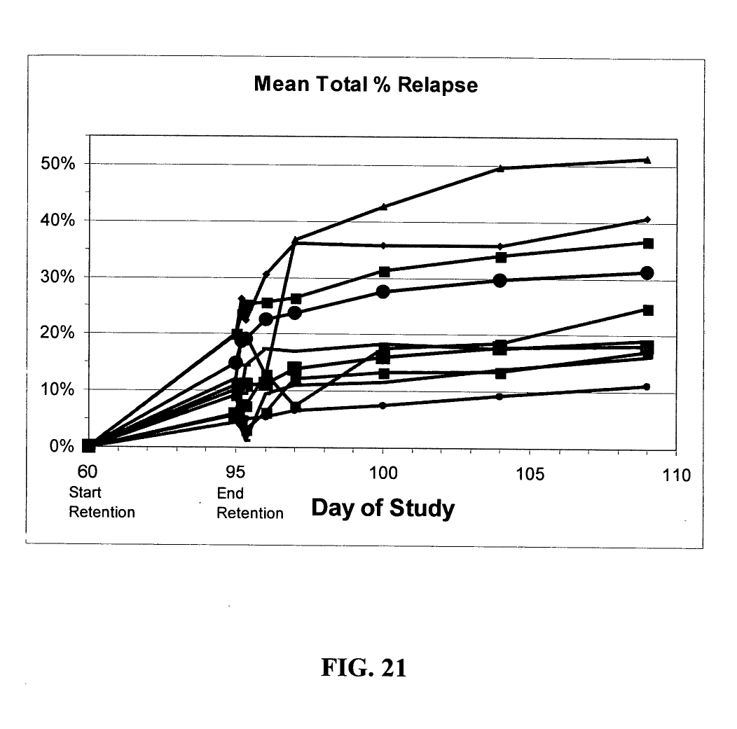

VIII. Prevention of Relapse This forth study shows that relaxin prevents relapse. Dogs were used in this study. FIG. 18 shows a diagram of the appliance used in the dog. Impressions in the dog were made at specific time lines during this 105 day study. Eight individual animals per group were used (see FIG. 21). One group (i.e., injected group) had gingival relaxin injections on days 50 and 55. Another group (i.e., control group) had placebo injections. The last group (i.e., fiberotomy group and positive control group) had a gingival fiberotomy on day 55. The individual animals in the gingival injection group were compared with the mean control and fiberotomy groups (see FIG. 21). Fiberotomy is a procedure in which the gingival fibers attached to the tooth are cut down to the alveolar bone as shown in FIG. 20. Fiberotomy has been effective in prevention of relapse in dogs as well as in clinical practice and was, thus, used as positive control.

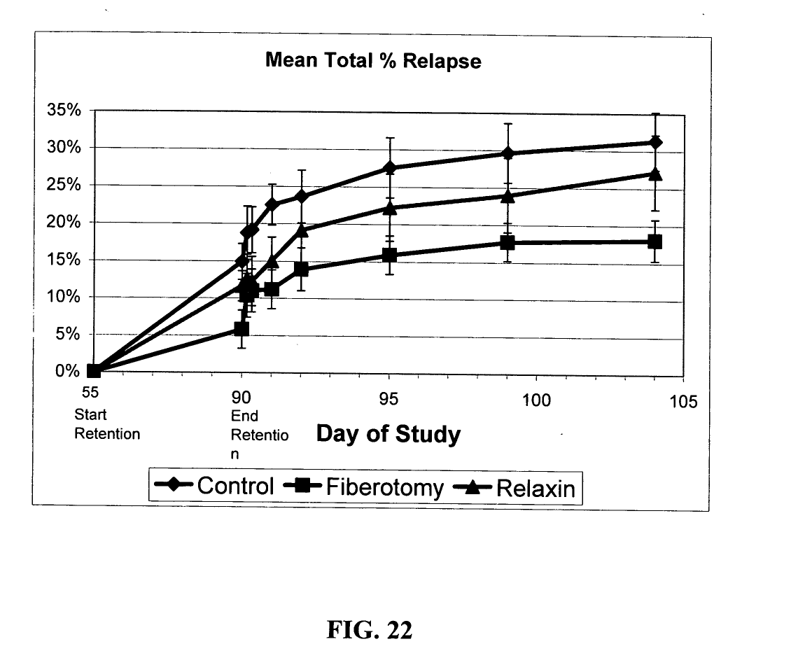

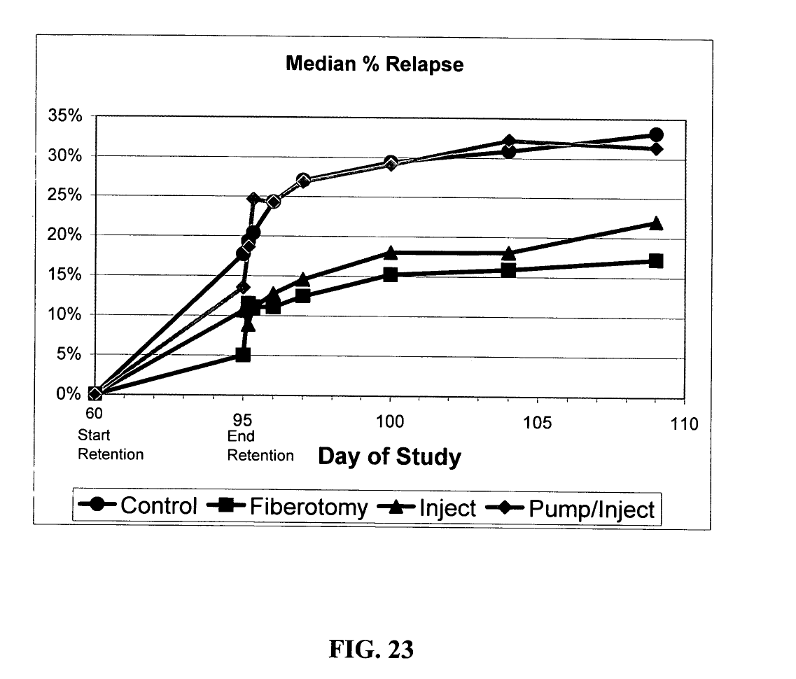

Alignate impressions were taken from the dogs and models were cast from them. Digital pictures of the models were used to measure the amount of rotation of the second maxillary incisor and its relapse. An average of 45 degrees of rotation was placed on the second maxillary incisor during the rotation phase. As shown on the graph in FIG. 22, the control group had relapse (˜30%) as expected. The fiberotomy and positive control group had significantly less relapse (p=0.014) than the control group as expected. The reduction in relapse is attributed to cutting the gingival fibers and relieving the stress. The injected group had results intermediate between the negative (control group) and positive (fiberotomomy and positive control group) groups when expressed as mean total percent relapse. This effect occurred with only two doses of relaxin which indicates that a slightly higher dose of relaxin administration will lead to an even more effective treatment in preventing relapse.

When the data shown above were expressed as median percent relapse, the results were even more promising. The data were plotted as medians instead of means in order to balance the groups better. This reduced the influence of outliers and allowed trends to be better visualized.

Control and Fiberotomy: these two control groups did not change in any noticeable way when using medians instead of means. There was still a difference between the two groups and the medians were similar to the means. This indicated that there was a uniform spread of the individual animals.

Relaxin Pump/Injected: expressing the data with medians made the Pump/Inject group virtually identical with the control group.

Relaxin Gingival Injection: expressing the data as medians instead of means caused the greatest change in the gingival injection group. While the mean of this group appeared midway between the two controls groups, the median appeared very similar with the fiberotomy group. This reflects the influence of three animals (the outliers) on the other five animals which showed promising results.

The fact that most animals were like the fiberotomy group suggested that this dose and schedule (i.e., two treatments 5 days apart) was sufficient to cause substantial remodeling similar to a gingival fiberotomy which is quite remarkable. The existence of three outliers (i.e., the failure of three animals to respond to the treatment) indicated most likely a delivery artifact or a failure to effectively target all the fibers in these particular three animals. It also suggested that normal delivery (i.e., when most or all fibers are targeted) is likely to assure the efficacy of this treatment since the overall results were promising (i.e., as seen with five out of eight animals).

While the above is a complete description of the preferred embodiments of the invention, various alternatives, modifications, and equivalents may be used. Therefore, the above description should not be taken as limiting the scope of the invention which is defined by the appended claims.

1. A method for treating relapse in a subject, said method comprising:
a) optionally applying force to at least one tooth in a jaw of said subject; and
b) administering at least one tissue remodeling and/or an angiogenic substance to said subject to promote remodeling of periodontal tissue surrounding a root of said at least one tooth, wherein said method results in at least 10% less relapse in said subject compared to treatment with a placebo.

2. The method of claim 1, wherein said force is applied over a continuous time period.

3. The method of claim 1, wherein said relapse is rotational relapse.

4. The method of claim 1, wherein said substance comprises relaxin.

5. The method of claim 4, wherein said relaxin is administered locally or systemically.

6. The method of claim 5, wherein the local administration comprises injecting said relaxin into gingival tissue.

7. The method of claim 6, wherein said relaxin is injected at a dosage of about 100 ng to 1 mg per said at least one tooth.

8. The method of claim 7, wherein said relaxin is injected at a dosage of about 50 μg per said at least one tooth.

9. The method of claim 5, wherein the local administration comprises topical delivery of said relaxin on gingival tissue near said at least one tooth.

10. The method of claim 9, wherein said relaxin is topically delivered at about 50 μg per said at least one tooth.

11. The method of claim 9, wherein said relaxin is topically delivered by releasing said relaxin from a controlled release device engaged against the gingival tissue.

12. The method of claim 9, wherein said relaxin is topically delivered by spreading a fluid substance over the gingival tissue.

13. The method of claim 9, wherein said relaxin is topically delivered by supplying relaxin to the gingival tissue via a patch.

14. The method of claim 1, wherein said at least one substance is administered before the force is applied.

15. The method of claim 1, wherein said at least one substance is administered while the force is applied.

16. The method of claim 1, wherein said at least one substance is administered after the force is applied.

17. The method of claim 1, wherein said method results in at least 10% to 40% less relapse in said subject compared to treatment with said placebo.

18. The method of claim 1, wherein said method results in at least 40% to 80% less relapse in said subject compared to treatment with said placebo.

19. The method of claim 1, wherein applying force comprises providing said subject with a removable or fixed appliance.

20. The method of claim 19, wherein the removable appliance comprises a reservoir which releases the substance to gingival tissue of said subject.

21. The method of claim 19, wherein the removable appliance is selected from the group consisting of positioners, aligners, retainers and trays.

22. The method of claim 19, wherein the fixed appliance is selected from the group consisting of brackets, bands, wires, auxiliaries, tubing, springs, coil springs, elastomeric ties, elastomaric modules, power chains, elastomeric threads and magnets.

23. The method of claim 1, further comprising applying an electric current to the periodontal tissue surrounding the root.

24. The method of claim 23, wherein the applied current has a current density in the range from 0.5 μA/mm² to 6 μA/mm².

25. A method for accelerating orthodontic tooth movement in a subject, said method comprising:
a) applying force to at least one tooth in a jaw of said subject; and
b) administering at least one tissue remodeling and/or an angiogenic substance to said subject to promote remodeling of periodontal tissue surrounding a root of said at least one tooth, thereby accelerating said orthodontic tooth movement.

26. The method of claim 25, wherein said at least one substance comprises relaxin.

27. The method of claim 26, wherein said relaxin is administered locally or systemically.

28. The method of claim 27, wherein the local administration comprises injecting said relaxin into gingival tissue.

29. The method of claim 28, wherein said relaxin is injected at a dosage of about 100 ng to 1 mg per said at least one tooth.

30. The method of claim 29, wherein said relaxin is injected at a dosage of about 50 μg per said at least one tooth.

31. The method of claim 27, wherein the local administration comprises administering said relaxin via an implantable pump.

32. The method of claim 31, wherein said relaxin is delivered at a rate of administration of about 10 μg per hour.

33. The method of claim 27, wherein the local administration comprises topical delivery of said relaxin on gingival tissue near said at least one tooth.

34. The method of claim 33, wherein said relaxin is topically delivered at a dosage of about 50 μg per said at least one tooth.

35. The method of claim 33, wherein said relaxin is topically delivered by releasing said relaxin from a controlled release device engaged against the gingival tissue.

36. The method of claim 33, wherein said relaxin is topically delivered by spreading a fluid substance over the gingival tissue.

37. The method of claim 25, wherein said at least one substance is administered before the force is applied.

38. The method of claim 25, wherein said at least one substance is administered while the force is applied.

39. The method of claim 25, wherein said at least one substance is administered after the force is applied.

40. The method of claim 25, wherein said force is applied over a continuous period of time.

41. The method of claim 25, wherein applying force comprises providing the subject with a removable or fixed appliance.

42. The method of claim 41, wherein the removable appliance comprises a reservoir which releases the substance to gingival tissue of the subject.

43. The method of claim 41, wherein the removable appliance is selected from the group consisting of positioners, aligners, retainers and trays.

44. The method of claim 41, wherein the fixed appliance is selected from the group consisting of brackets, bands, wires, auxiliaries, tubing, springs, coil springs, elastomeric ties, elastomaric modules, power chains, elastomeric threads and magnets.

45. The method of claim 25, further comprising applying an electric current to the periodontal tissue surrounding the root.

46. The method of claim 45, wherein the applied current has a current density in the range from 0.5 μA/mm² to 6 μA/mm².

47. An orthodontic kit, said kit comprising:
(a) a structure mountable on or over at least a portion of at least one tooth in a jaw of a subject, wherein said structure applies force to said at least one tooth in the jaw;
(b) a tissue remodeling and/or an angiogenic substance capable of remodeling the periodontium near a root of the tooth; and
(c) instructions for delivery of said substance to said subject.

48. The method of claim 47, wherein said structure is mountable over at least a portion of at least two teeth.

49. The kit of claim 47, wherein said structure is selected from the group consisting of positioners, aligners, retainers, trays, brackets, bands, wires, auxiliaries, tubing, springs, coil springs, elastomeric ties, elastomaric modules, power chains, elastomeric threads and magnets.

50. The kit of claim 49, wherein said structure further comprises an electrical supply and one or more batteries.

51. The kit of claim 47, wherein said structure is positioned over a portion of the jaw.

52. The kit of claim 47, wherein said structure is positioned over the entire jaw.

53. The kit of claim 47, wherein said structure is positioned over at least two teeth in the jaw.

54. The kit of claim 47, wherein said structure is positioned over all teeth in the jaw.

55. The kit of claim 47, wherein said periodontium is selected from the group consisting of gingiva, periodontal ligament (PDL) and bone.

56. The kit of claim 47, wherein said substance is relaxin.

57. The kit of claim 47, wherein said substance is stored in a separate container.

58. The kit of claim 47, wherein said substance is stored in the structure.

59. The kit of claim 58, wherein said structure comprises a porous material which releases the substance at a controlled rate over time.

60. The kit of claim 59, wherein said porous material comprises a chamber.
